(19) United States
(12) Patent Application Publication
(10) Pub. No.: US 2010/0293559 A1
(43) Pub. Date: Nov. 18, 2010

(54) SHARING INPUT/OUTPUT (I/O) RESOURCES ACROSS MULTIPLE COMPUTING SYSTEMS AND/OR ENVIRONMENTS

(75) Inventors: Onur Aciicmez, San Jose, CA (US); Doreen Cheng, San Jose, CA (US); Swaroop S. Kalasapur, Santa Clara, CA (US); Yu Song, Pleasanton, CA (US); Xinwen Zhang, San Jose, CA (US); Victoria S. Coleman, Menlo Park, CA (US)

Correspondence Address: Beyer Law Group LLP/ SISA, P.O. Box 1687, Cupertino, CA, 95015-1687, US

(73) Assignee: SAMSUNG ELECTRONICS CO., LTD., Suwon City, Gyeonggi-Do (KR)

(21) Appl. No.: 12/464,507

(22) Filed: May 12, 2009

(51) Int. Cl. G06F 9/46; G06F 3/00

(52) U.S. Cl. 719/324; 710/7

(57) ABSTRACT

Techniques for achieving Input/Output I/O coalition across multiple computing systems and/or environments (e.g., computing devices) are disclosed. I/O coalition can be achieved by allowing one or more internal I/O devices of a first computing device to be effectively shared with a second computing device while one or more I/O devices of the second computing device is effectively shared with the first computing device. An Input-Output Coalition Management (IOCM) system can be provided for each the computing devices to facilitate I/O coalition between them. An IOCM system can, for example, be provided as Virtual Input-Output Computing Environment (VIOCE). By way of example, one or more Virtual Machines (VMs) can be provided to effectively support one or more Virtual Device Drivers (VDDs). An IOCM system can also be provided as and/or by an Operating System (OS). Furthermore, an IOCM system of a first computing device can be operable to switch between: (i) use of a first I/O device of the first computing device, (ii) use of a second I/O device of a second computing device, and (iii) use of a third I/O device of a third computing device.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information is stored in a computer readable medium in a binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power. The computing devices that are available today include: expensive and powerful servers, relatively cheaper Personal Computers (PC's) and laptops and yet less expensive microprocessors (or computer chips) provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

Generally, Input/Output (I/O) devices and I/O operations are an important part of computing devices. An Input/Output (I/O) device can perform one or more input and/or output functions and/or tasks including the mere act of communication of data to an entity (e.g., a person, a computing device, or processing system).

Some I/O devices have been in use for many years now. These I/O devices include a mouse, a keyboard and a printer which all are usually provided for Personal Computers (PCs). More recently, other I/O devices including modems and various other network devices have become widely available. Some other I/O devices including Global Positioning Systems (GPS) and Barcode Readers are becoming increasing more available in various computing devices. In the future, even more I/O devices are likely to be provided especially for wireless mobile devices (e.g., smart phones, cell phones) as more capabilities are likely to be provided.

The popularity of computing systems is evidenced by their ever increasing use in everyday life. Accordingly, techniques that can improve computing systems would be very useful.

### SUMMARY OF THE INVENTION

Broadly speaking, the invention relates to computing systems and computing environments. More particularly, the invention pertains to techniques for sharing input/output (I/O) resources.

In accordance with one aspect of the invention, one or more internal input output (I/O) devices of a first computing system and/or environment (e.g., a first computing device) can be effectively shared with one or more other computing systems and/or environments (e.g., one or more other computing devices) while one or more external resources of the other computing systems and/or environments can be effectively shared with the first computing system and/or environment.

In accordance with one embodiment of the invention, a computing device can include an Input-Output Coalition Management (IOCM) system operable to facilitate sharing of one or more internal input output (I/O) devices of the computing device with one or more other computing devices. In addition, the Input-Output Coalition Management (IOCM) system can be operable to facilitate sharing of one or more external input output (I/O) devices of other computing devices with the computing device and/or yet other computing devices.

It will be appreciated that the Input-Output Coalition Management (IOCM) system can, for example, be provided as a Virtual Input-Output Computing Environment (VIOCE). By way of example, one or more Virtual Machines (VMs) can be provided to effectively support one or more Virtual Device Drivers (VDDs) as will be appreciated by those skilled in the art. Those skilled in the art will also appreciate that the Input-Output Coalition Management (IOCM) system can also be provided as an Operating System (OS) and/or by the Operating System (OS). Furthermore, the Input-Output Coalition Management (IOCM) system can be operable to switch between: (i) use of a first internal input output (I/O) device of the computing device, (ii) use of a first external input output (I/O) device of a first external device, and (iii) use of a second external input output (I/O) device of a second external device.

The invention can be implemented in numerous ways, including, for example, a method, an apparatus, a computer readable (and/or storable) medium, and a computing system (e.g., a computing device). A computer readable medium can, for example, include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing device in accordance with one embodiment of the invention.

FIG. 1B depicts an exemplary method for providing one or more input and/or functions in accordance with one embodiment of the invention.

FIGS. 1C and 1D depict an exemplary method for providing one or more input and/or output functions in accordance with another embodiment of the invention.

FIG. 2 depicts a computing device in accordance with another embodiment of the invention.

FIG. 3 depicts a computing device in accordance with yet another embodiment of the invention.

FIG. 4 depicts a computing environment in accordance with one embodiment of the invention.

FIG. 5 depicts an exemplary OS-based Input-Output Coalition Management (IOCM) system for a Linux OS in accordance with one embodiment of the invention.

FIG. 6 depicts a Coalition Management Layer (CML) in accordance with another embodiment of the invention.

FIG. 7 depicts a Coalition Management Layer (CML) in accordance with yet another embodiment of the invention.

FIG. 8 depicts an Input-Output Coalition Management (IOCM) system in accordance with yet another embodiment of the invention.

### DETAILED DESCRIPTION OF THE INVENTION

As noted in the background section, input/output (I/O) is an important part of computing systems and environments. Accordingly, improved techniques for using input/output (I/O) in computing systems and environments would be very useful.

The invention pertains to techniques for sharing input/output (I/O) in computing systems and environments. In accordance with one aspect of the invention, one or more internal input output (I/O) devices of a first computing system and/or environment (e.g., a first computing device) can be effectively shared with one or more other computing systems and/or environments (e.g., one or more other computing devices) while one or more external resources of the other computing systems and/or environments can be effectively shared with the first computing system and/or environment.

In accordance with one embodiment of the invention, a computing device can include an Input-Output Coalition Management (IOCM) system operable to facilitate sharing of one or more internal input output (I/O) devices of the computing device with one or more other computing devices. In addition, the Input-Output Coalition Management (IOCM) system can be operable to facilitate sharing of one or more external input output (I/O) devices of other computing devices with the computing device and/or yet other computing devices.

It will be appreciated that the Input-Output Coalition Management (IOCM) system can, for example, be provided as a Virtual Input-Output Computing Environment (VIOCE). By way of example, one or more Virtual Machines (VMs) can be provided to effectively support one or more Virtual Device Drivers (VDDs) as will be appreciated by those skilled in the art. Those skilled in the art will also appreciate that the Input-Output Coalition Management (IOCM) system can also be provided as an Operating System (OS) and/or by an Operating System (OS). Furthermore, the Input-Output Coalition Management (IOCM) system can be operable to switch between: (i) use of a first internal input output (I/O) device of the computing device, (ii) use of a first external input output (I/O) device of a first external device, and (iii) use of a second external input output (I/O) device of a second external device.

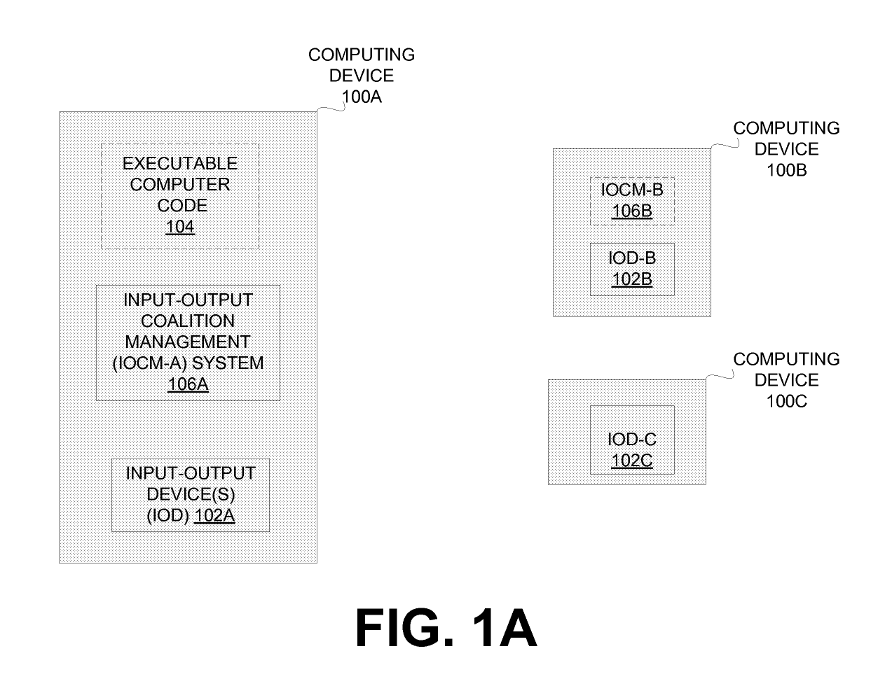

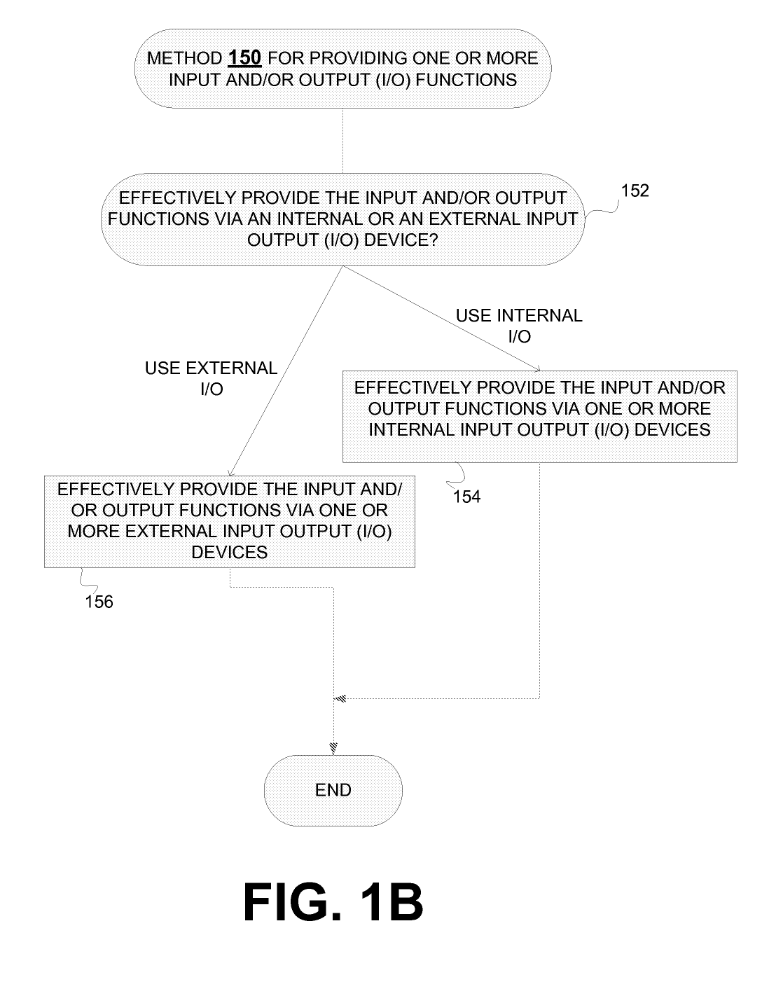

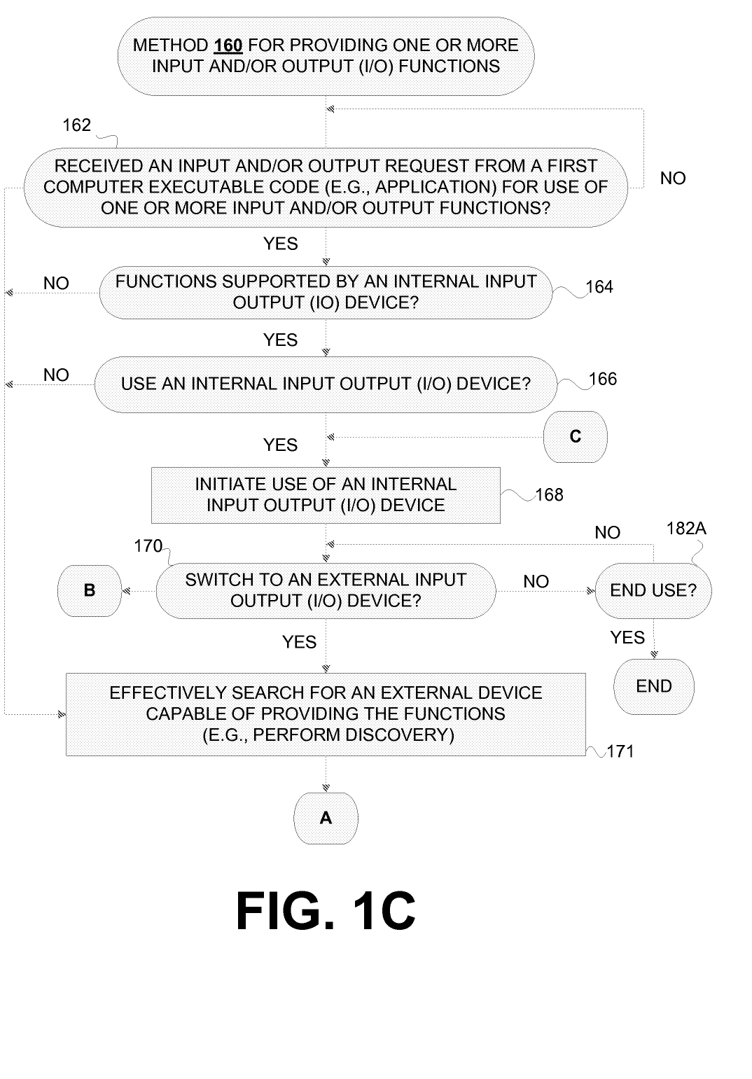

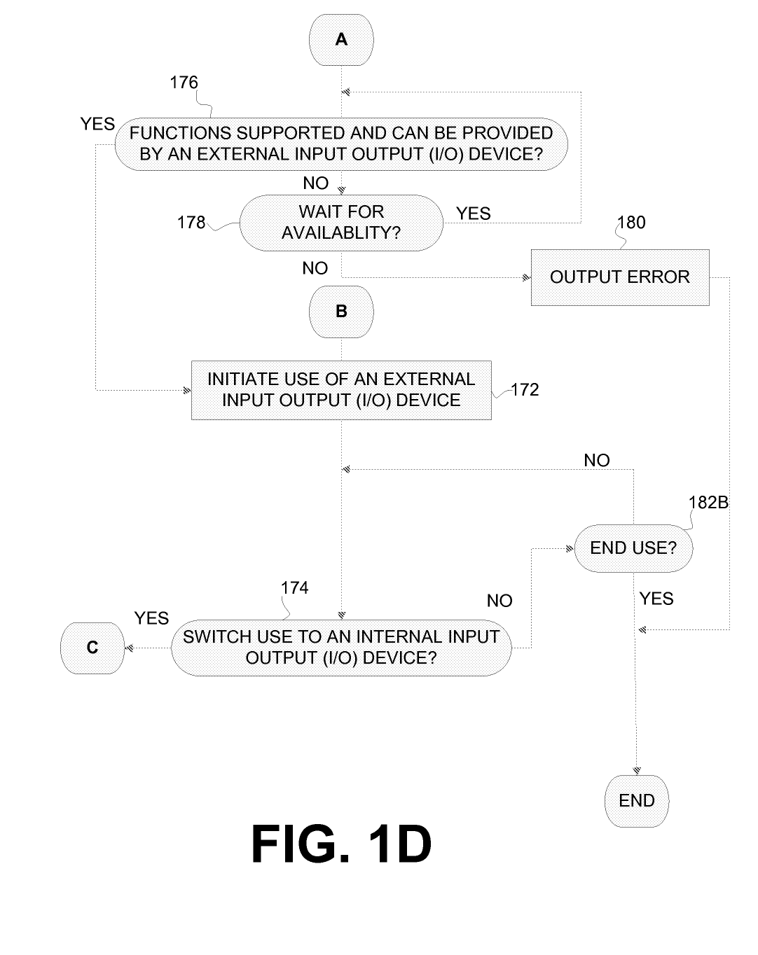

Embodiments of these aspects of the invention are discussed below with reference to FIGS. 1A-8. However, those skilled in the art will readily appreciate that the detailed description given herein with respect to these figures is for explanatory purposes as the invention extends beyond these limited embodiments.

FIG. 1A depicts a computing device 100A in accordance with one embodiment of the invention. Referring to FIG. 1A, the computing device 100A includes one or more input output (I/O) devices (or internal I/O devices) 102A operable to provide one or more input and/or output (I/O) functions that can, for example, be effectively used by executable computer code (e.g., computer application program) 104. In other words, the computing device 100A can be operable to effectively execute executable computer code 104 and effectively provide the executable computer code 104 with various input and/or output (I/O) functions of the one or more internal I/O devices 102A during execution time. Those skilled in the art will readily know that the computing device 100A can, for example, include one or more processors and memory (not shown) that can effectively support execution of the executable code 104.

Moreover, it will be appreciated that the computing device 100A can be operable to effectively facilitate use and/or allow use of the one or more internal I/O devices 102A by one or more other computing devices. In other words, an Input-Output Coalition Management (IOCM) system 106A can effectively facilitate sharing of the Input-Output (I/O) devices 102A with other computing devices. Referring to FIG. 1A, an Input-Output Coalition Management (IOCM) system 106A of the computing device 100A can be operable to effectively facilitate use or allow use, or cause use of the internal I/O devices 102A by the computing device 100A and/or 100B.

In addition, IOCM system 106A of the computing device 100A can be operable to effectively use one or more external input output (I/O) devices of one or more external I/O devices. Referring to FIG. 1A, IOCM system 106A can be operable to effectively use one or more external input output (I/O) devices 102B of the computing device 100B and/or one or more external input output (I/O) devices 102C of the computing device 100C.

As shown in FIG. 1A, an Input-Output Coalition Management (IOCM) system 106B may be effectively provided by the computing device 100B. As a result, the computing device 100B can be operable to effectively facilitate sharing of its internal I/O devices 102A, namely, I/O devices 102B with the computing device 100A and effectively use the I/O devices 102A of the computing device 10A.

Generally, Input-Output Coalition Management (IOCM) system 106A can be operable to effectively provide one or more input and/or output (I/O) functions via internal and external input output (I/O) devices. In other words, the IOCM system 106A can be operable to allow the computing device 100A to use various combinations of internal (102A) and external input output (IO) devices (102B and 102C) provided by other computing devices as external resources to the extend and is the external resources become available and/or are made available to the computing device 100A.

However, it should be noted that a particular or specific input output (I/O) request can be effectively served using an internal or an external input device at a given time. In other words, Input-Output Coalition Management (IOCM) system 106A can be operable to determine whether to provide one or more input and/or output (I/O) functions via an internal (102A) or an external input output (I/O) device (102B and 102C) and effectively provide the I/O functions accordingly.

To further elaborate, FIG. 1B depicts an exemplary method 150 for providing one or more input and/or output (I/O) functions in accordance with one embodiment of the invention. Method 150 can, for example, be used by the computing device 100A depicted in FIG. 1A. Referring to FIG. 1B, initially, it is determined (152) whether to effectively provide one or more input and/or output (I/O) functions via an internal or an external input output (I/O) device. If it is determined (152) to effectively provide one or more input and/or output (I/O) functions via an internal input output (I/O) device, the one or more I/O functions are provided (154) using an internal I/O device before the method 150 ends. However, if it is determined (152) to effectively provide one or more input and/or output (I/O) functions via an external input output (I/O) device, the one or more I/O functions are provided (156) using an external I/O device before the method 150 ends.

To elaborate even further, FIGS. 1C and 1D depict an exemplary method 160 for providing one or more input and/or output (I/O) functions in accordance with another embodiment of the invention. Method 160 can, for example, be used by the computing device 100A depicted in FIG. 1A. Method 160 can also represent, in greater detail, the operations of method 150 depicted in FIG. 1B. Referring to FIG. 1C, initially, it is determined (162) whether an input and/or output (IO) request has been received from executable computer code (e.g., an application program). Typically, the request is received from an application program being executed on a computing device. Generally, the request can be received from various types of executable computer code being executed locally or remotely on other computing devices. In effect, the method 160 can wait to receive an input and/or output (IO) request. Referring back to FIG. 1C, when it is determined (162) that an input and/or output request has been received, the method 160 proceeds to determine (164) whether the one or more requested I/O functions are supported by an internal input output (I/O) device. If it is determined (164) that the one or more requested I/O functions are supported by an internal input output (I/O) device, it is determined (166) whether to use the internal I/O device. The determination (166) can, for example, be based on one or more factors including whether the internal I/O device is considered to be “busy” serving a number of application programs, the relative monetary cost associated with using an internal I/O device versus the cost associated with using an external I/O device, current network bandwidth for accessing an external I/O device, and so on. If it is determined (166) to use an internal I/O device to provide the requested I/O functions, use of the internal I/O device is initiated (168). Next, it is determined (170) whether to switch to an external I/O device. The determination (170) can, for example, be based on one or exemplary factors noted above. In other words, it can be determined (170) whether to use an external I/O device instead of the internal I/O device in order to provide the one or more I/O functions. Accordingly, if it is determined (170) to switch to an external I/O device, the method 160 proceeds to initiate (172) use of an external I/O device in order to provide the requested I/O functions (shown in FIG. 1D). Referring now to FIG. 1D, after initiating (172) use of an external device, it can be determined (174) whether to switch to an internal I/O device in order to provide that one or more requested I/O functions. As a result, the executable computer code that request the I/O functions can be served using internal and external I/O devices in a dynamic manner.

Referring back to FIG. 1C, it should be noted that if it is determined (164) that the one or more requested functions are not supported by an internal I/O device, or it is determined (166) not to use an internal I/O device, the method 160 can effectively search for an external device that can provide the one or more requested functions. By way of example, a “discovery” operation can be performed as will be appreciated by those skilled in the art. Referring now to FIG. 1D, it can be determined (176) whether the one or more requested I/O functions are supported and can be provided by an external I/O device. If it is determined (176) that the one or more I/O functions are not supported or cannot be provided on an external I/O device, the method 160 can effectively wait (178) for an external device to become available. The determination (178) can represent a design choice and/or can be performed based on various factors including, for example, waiting for a determined amount of time for an external I/O device to be become available. As a result, an error (e.g., error message) can be output (180) before the method 160 ends. However, if it is determined (178) that the one or more I/O functions are supported and can be provided by an external I/O device, use of an external device is initiated (172) in order to effectively provide the one or more requested I/O functions to executable computer code. Method 160 ends when it is determined (182A or 182B) that the requested I/O functions are no longer needed so that the effective use of the I/O device can end.

Those skilled in the art will appreciate that an Input-Output Coalition Management (IOCM) (e.g., IOCM 106A depicted in FIG. 1A) can effectively provide and/or be provided as a Virtual Input-Output Computing Environment (VIOCE) operable to effectively simulate an internal input output (I/O) environment when an external I/O device is used instead of an internal I/O device. In addition or alternatively, a Virtual Input-Output Computing Environment (VIOCE) can be operable on a first computing device to effectively simulate an I/O environment for an external computing device that uses an internal I/O device of the first computing device.

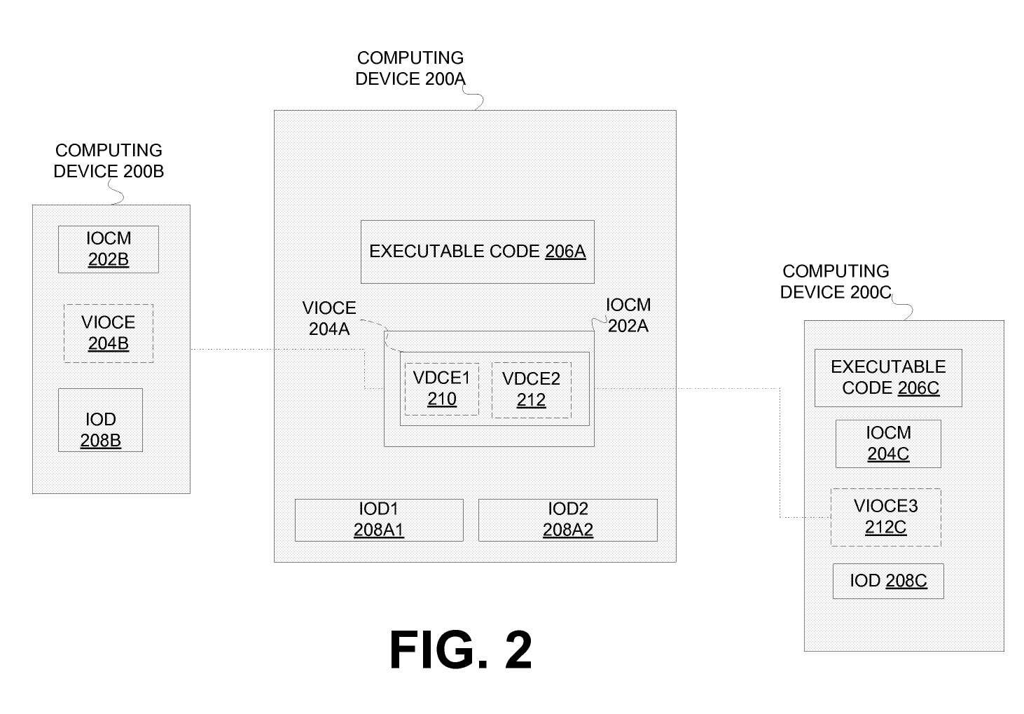

To further elaborate, FIG. 2 depicts a computing device 200A in accordance with another embodiment of the invention. Referring to FIG. 2, an Input-Output Coalition Management (IOCM) system 202A of the computing device 200A includes a Virtual Input-Output Computing Environment (VIOCE) 204A. Generally, VIOCE 204A can be operable to effectively simulate an internal I/O environment for executable code 206A when an external I/O device 208B of an external computing device 200B is being used by the executable code 206A instead of an internal I/O device 208A of the computing device 200A (IO devices 208A1 and 208A2). More particularly, the Virtual Input-Output Computing Environment (VIOCE) 204A can initiate a first Virtual Device Computing Environment (VDCE1) 210 operable to effectively simulate an internal device computing environment for the executable code 206A even though an external I/O device 208B is providing actual input and output functions and/or services to the executable code 206A. By way of example, first Virtual Device Computing Environment (VDCE1) 210 can be provided as a virtual device driver as will be readily known to those skilled in the art. In any case, Virtual Device Computing Environment (VDCE1) 210 can serve as an interface to the executable code 206A allowing it to use the external I/O device 208B in the same manner as the executable computer code 206A would use and internal I/O device of the computing device 200A (208A1 and 208A2). As a result, the first executable computer code 206A (e.g., a first computer application program) would not require modifications of its existing I/O interface or addition of a new interface in order to use the external I/O device 208B. Furthermore, the first executable computer code 206A would not have to explicitly request the use of an external device or specifically make a request for a particular external device.

As depicted in FIG. 2, the computing device 200B can also include an Input-Output Coalition Management (IOCM) system 202B. It will be appreciated that the IOCM system 202B can effectively collaborate with the IOCM system 202A to facilitate sharing the I/O devices 208B and 208A between the computing devices 200B and 200A. Similar to IOCM system 202A, the IOCM system 202B can effectively provide and/or be supported by a Virtual Input-Output Computing Environment (VIOCE) system 204B.

Referring to FIG. 2, the Virtual Input-Output Computing Environment (VIOCE) 204A of the computing device 200A may also provide a second Virtual Device Computing Environment (VDCE2) 212 operable to effectively simulate a device computing environment for use by executable code 206C being executed by the computing device 200C. However, it should be noted that the second Virtual Device Computing Environment (VDCE2) 212 may be provided by the computing device 200C (shown as (VIOCE3) 212C in FIG. 2).

Those skilled in the art will also appreciate that an Input-Output Coalition Management (IOCM) system (e.g., IOCM system 106A depicted in FIG. 1A) can be effectively provided as, or by, an Operating System (OS) operable on a computing device (e.g., computing device 100A depicted in FIG. 1A). In other words, an Operating System (OS) can be operable to provide similar as that provided by a Virtual Input-Output Computing Environment (VIOCE).

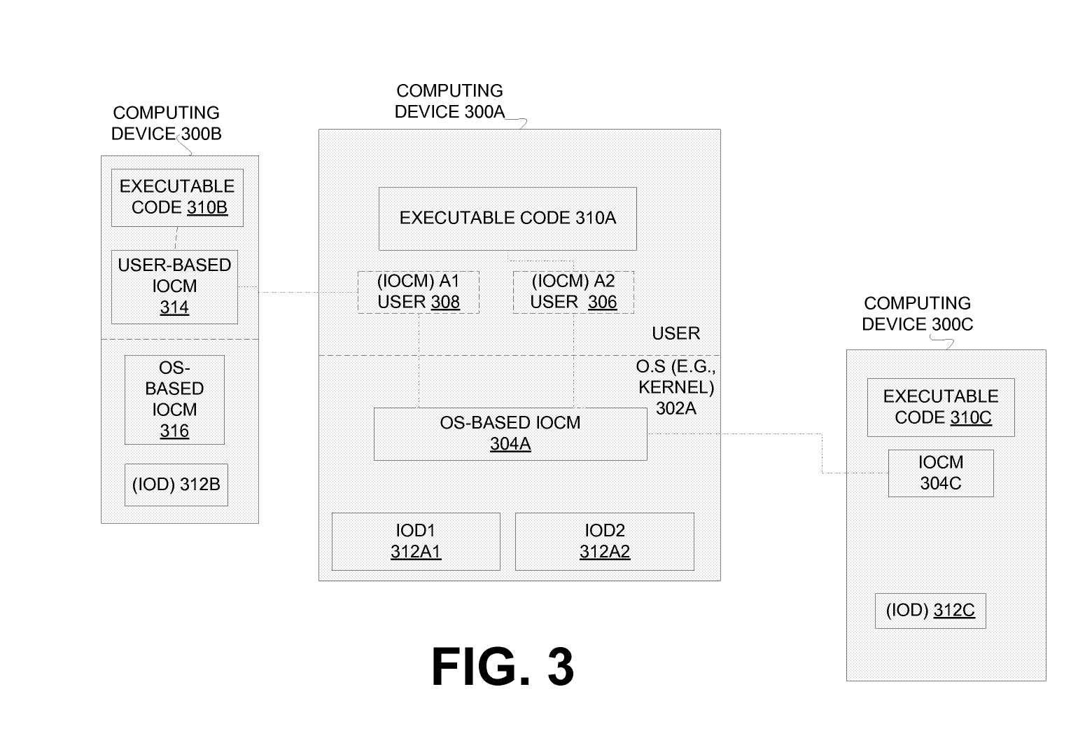

To further elaborate, FIG. 3 depicts a computing device 300A in accordance with yet another embodiment of the invention. Referring to FIG. 3, an Input-Output Coalition Management (IOCM) capable Operating System (or IOCM-capable OS) 302A can effectively provide an Operating-System-based (or OS-based) Input-Output Coalition Management (IOCM) 304A in the OS space. Those skilled in the art will appreciate that the Operating-System-based Input-Output Coalition Management (IOCM) 304A can be operable to provide functionality similar to that which can be provided by virtual computing environments including, for example, the Device Computing Environments (VDCEs) 210 and 212 depicted in FIG. 2.

Generally, at least a portion of an Input-Output Coalition Management (IOCM) system (e.g., IOCM 106A depicted in FIG. 1A) can be provided by an Operating System (OS). Referring back to FIG. 3, an Input-Output Coalition Management (IOCM) system can be collectively provided by the Operating-System-based Input-Output Coalition Management (IOCM) 304A in the OS space and one or more user-based Input-Output Coalition Management (IOCM) 306 and 308 operating in user space of the computing device 300A. The user space based Input-Output Coalition Management (IOCM) 306 can effectively serve as an interface to the executable computer code 310A and provide various functionality (e.g., discovery) and store data (e.g., tables) that need not be provided by or stored in the OS. The executable code 310A can effectively request one or more I/O functions via the user-based Input-Output Coalition Management (IOCM) 306. The I/O functions can be provided via the OS-based Input-Output Coalition Management (IOCM) 304A by using an external I/O device, namely, an IO device 312C of a computing device 300C, instead of the internal I/O devices of the computing device 300A (312A1 and 312A2). Referring to FIG. 3, the computing device 300C may be operable to effectively provide an Input-Output Coalition Management (IOCM) system 304C. The I/O functions or I/O devices 312C can be provided via the Input-Output Coalition Management (IOCM) system 304C which can be provided as an OS-based IOCM system or as a Virtual Input-Output Computing Environment (VIOCE).

Referring to FIG. 3, a computing device 300B can effectively provide user-based and OS-based IOCM components 314 and 316 collectively providing an IOCM system, similar to the computing device 300A. Executable computer code 310B can effectively use the user-based IOCM component 314 to access one or more of the I/O devices of the computing device 300A, namely, I/O devices 208A1 and 208A2. This access can be initiated by communication with the user-based IOCM component 308 of the computing device 300A. I/O functions and/or services can be provided via the OS-based IOCM component 304A to effectively allow the executable computer code 310B being executed on the computing device 300B to use the I/O devices 312A1 and 312A2 of the computing device 300A.

Generally, Input-Output Coalition Management (IOCM) system can manage I/O devices and in particular I/O device drivers. This can, for example, be achieved by providing an I/O management software layer to existing virtualization software and/or existing native Operating System (OS).

Those skilled in the art will readily appreciate that a Virtual Input-Output Computing Environment (VIOCE) can, for example, be provided by one or more Virtual Machines (VMs) and/or Virtual Machine Monitors (VMM). A VIOCE can use one or more Virtual Device Drivers (VDDs) in order to effectively interface with Actual (or physical) Device Drivers (ADD).

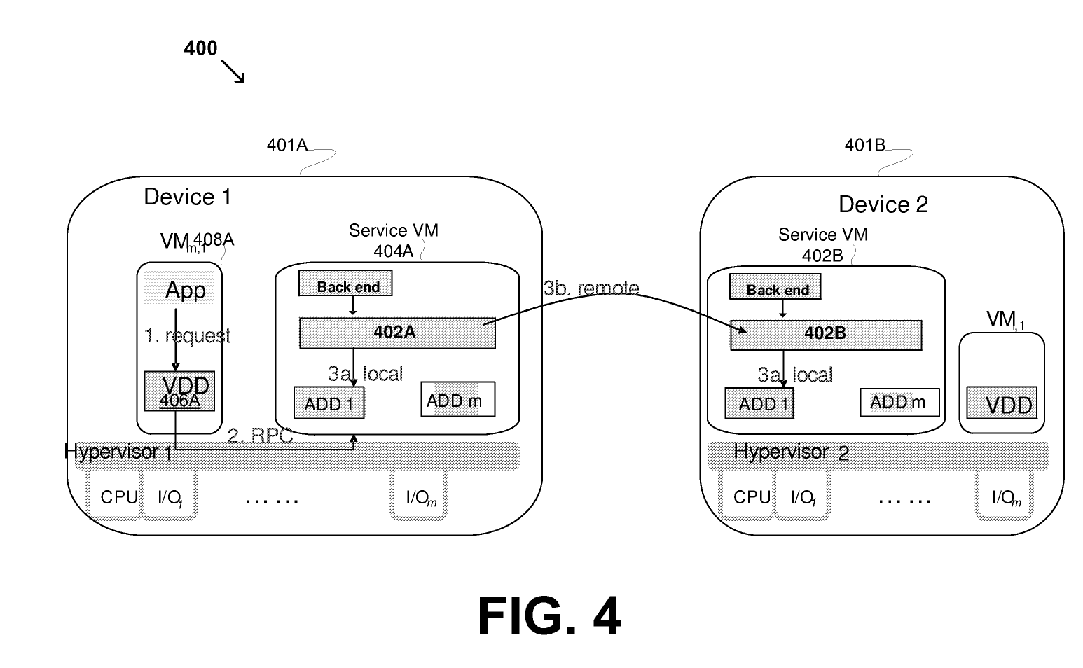

To further elaborate, FIG. 4 depicts a computing environment 400 in accordance with one embodiment of the invention. Referring to FIG. 4, an Input-Output Coalition Management (IOCM) layer (system or system component) 402A is provided in a Service Virtual Machine (SVM) 404A for a device 401A. As shown in FIG. 4, the IOCM layer 402A can be effectively provided on top of the Actual Device Drivers (ADDs) of the computing device 401A. A computer application program can effectively send a request for I/O functions and/or services (I/O request) when it tries to access an I/O resource. This I/O request can be processed by a Virtual Device Driver (VDD) 406A operating in a Virtual Machine 408A that can serve as a “front-end.” The Virtual Device Driver (VDD) 406A can forward the I/O request to the IOCM layer 402A of the SVM 404A. The IOCM layer 402A can determine whether to serve the I/O request using an internal (or local) I/O device of the computing device 401A or service it remotely using an external (or remote) I/O device. As such, the IOCM layer 402A may effectively forward the I/O request to an IOCM layer 402B of another computing device, namely, the computing device 401B. As a result, the I/O request may actually be served by an I/O device of the computing device 401B instead of an I/O device of the computing device 401A.

It should be noted that an IOCM system can be provided as one or more of the following: (i) as two or more separate software layers, modules, of components between one or more Actual Device Drivers (ADDs) and “back end” VMs, (ii) a single (or incorporated) software layer, module, of component with “back end” VMs that are effectively blended together, (iii) as a part of a VMM (or a Hypervisor) without a SVM, (iv) as a part of a dedicated VM on a device different than the device that effectively hosts the Actual Device Drivers (ADDs). In view of the foregoing, other variations and combinations will be readily known and consequently appreciated by those skilled in the art.

As noted above, an IOCM system can also be provided as a part of or effectively by, an Operating System (OS) including: a “native” OS in a non-virtualized platform, and an OS within a virtualized platform, as will be readily known and consequently appreciated by the skilled in the art. Generally, an OS-based IOCM system can be provided in a similar manner as that described above with respect to virtualization techniques in the computing environment 400 depicted in FIG. 4. A “logical” layer can be added to an existing OS to effectively handle I/O coalition in the OS in accordance with the invention. This “logical” layer can be a logical layer in the sense that it can, for example, be implemented as a new layer in various existing implementations of an OS, or incorporated, blended and/or bundled in one or more existing software layers and/or software modules of the OS within a structural organization of the OS.

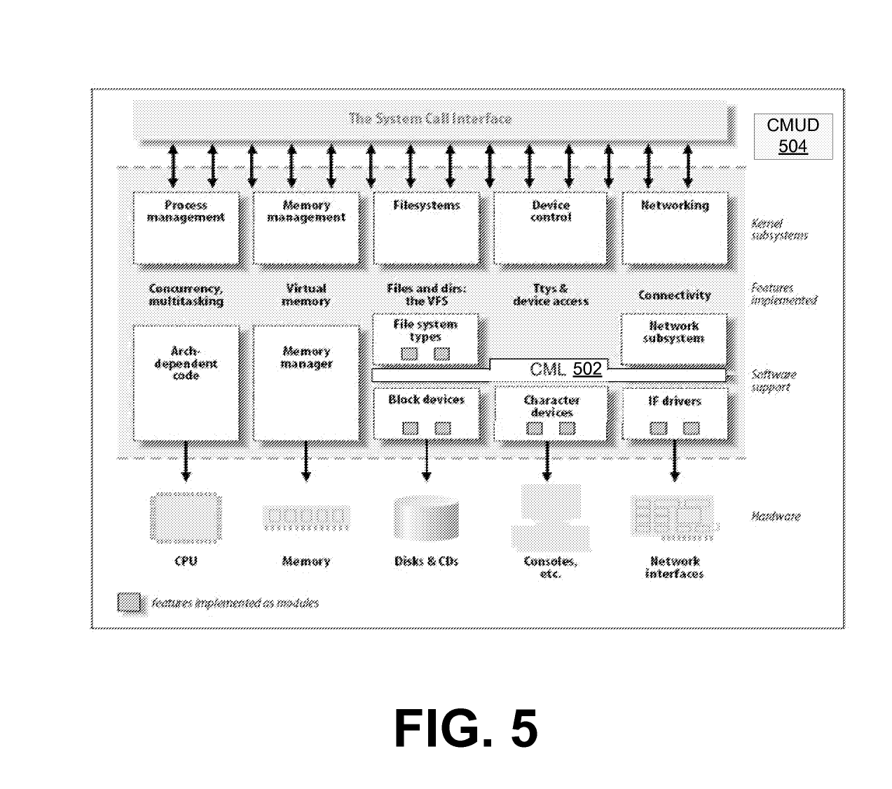

FIG. 5 depicts an exemplary OS-based IOCM system for a Linux OS in accordance with one embodiment of the invention. Referring to FIG. 5, an OS-based IOCM system is provided by a Coalition Management Layer (CML) 502 and a Coalition Management User Daemon (CMUD) 504. As shown in FIG. 5, the Coalition Management Layer (CML) 502 can, for example, be effectively provided on top of the various Device Drivers (DD's) including block, character and Interfacing (IF) Device Drivers inside the kernel. The CMUD 504 can operate in user space and provide various functions that need not be provided inside the kernel (e.g., discovery, storing and/or accessing tables).

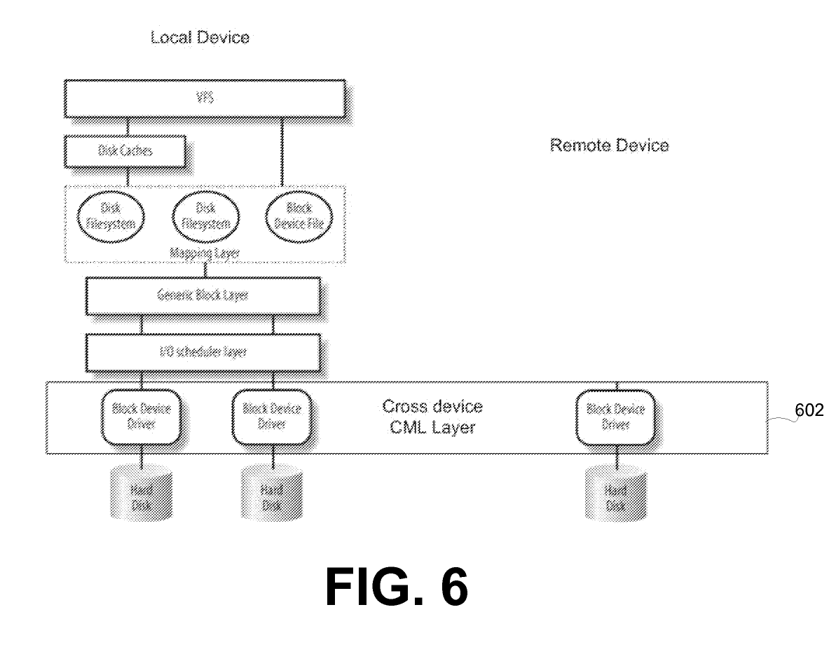

As generally known in the art, an operation on a block device driver can involve a relatively large number of kernel components in a Linux operating environment. FIG. 6 depicts a Coalition Management Layer (CML) 602 in accordance with another embodiment of the invention. Referring to FIG. 6, a Coalition Management Layer (CML) 602 is provided between a Linux I/O scheduler layer and device drivers. As will be appreciated by those skilled in the art, the Coalition Management Layer (CML) 602 can, for example, be provided as a separate layer on top of the device drivers or it can effectively incorporate the device drivers.

It should be noted that in order to provide a more dynamic solution with respect to I/O coalition, a Coalition Management Layer (CML) layer may be operable to inform the upper layers of any changes with respect to I/O devices as they become available or effectively withdraw their services. As a result, the upper layers may have to be modified in order to allow I/O coalition in a more dynamic manner. In other words, a Coalition Management Layer (CML) layer can be effectively distributed among multiple layers.

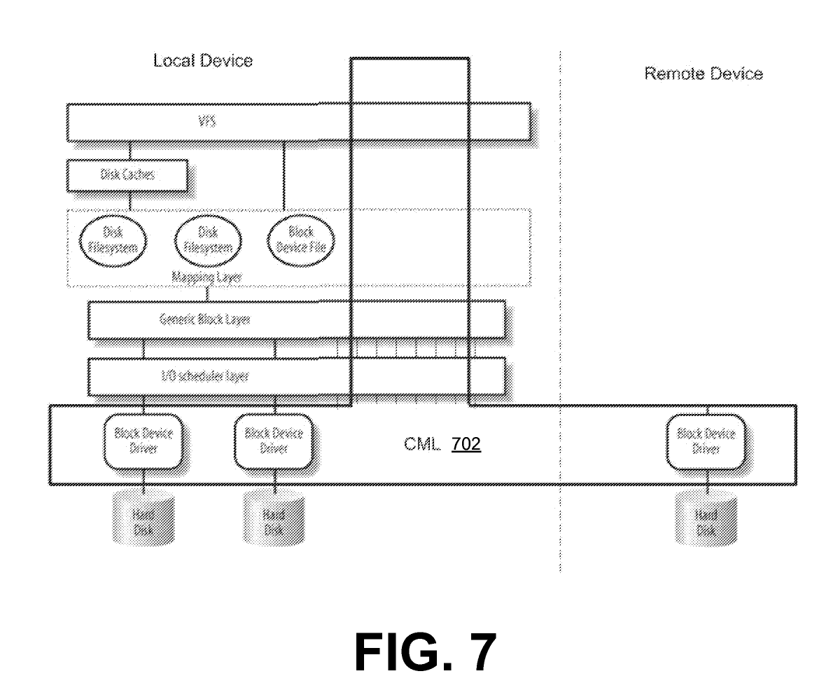

To further elaborate, FIG. 7 depicts a Coalition Management Layer (CML) 702 in accordance with yet another embodiment of the invention. Referring to FIG. 7, a Coalition Management Layer (CML) 702 can be effectively provided by multiple software layers as will be appreciated by those skilled in the art.

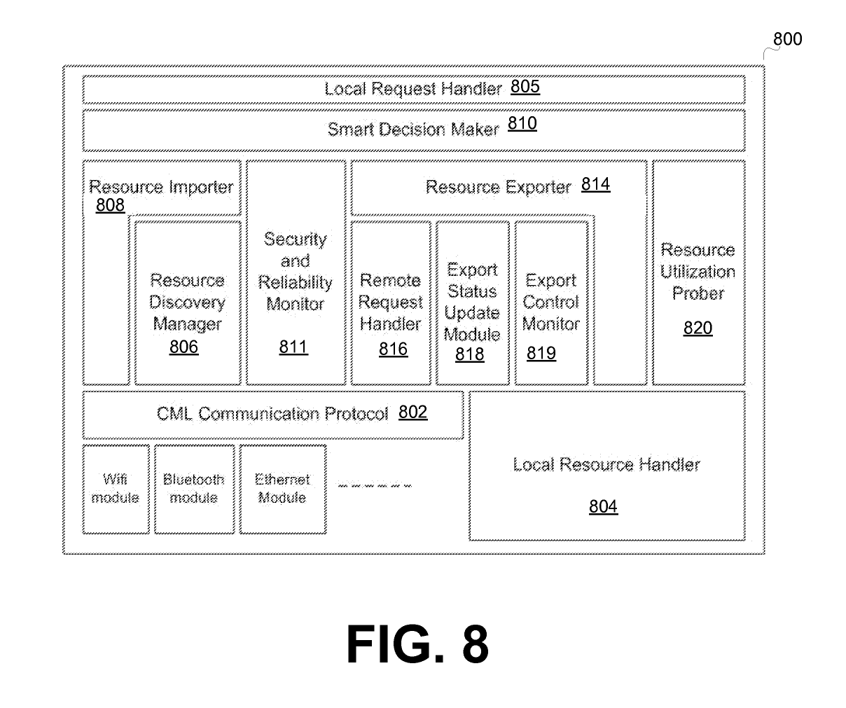

FIG. 8 depicts an Input-Output Coalition Management (IOCM) system 800 in accordance with yet another embodiment of the invention. More particularly, FIG. 8 depicts a number of exemplary components of an IOCM system that can be provided in a device 800. Referring to FIG. 8, a Coalition Management Layer (CML) Communication Protocol Module (or component) 802 can be operable to handle the exchange of messages related to I/O Coalition between the device 800 and various other devices. Such messages can, for example, be delivered over WiFi networks, Bluetooth, Ethernet connections, etc. The CML Communication Protocol Module 802 relies on the local communication devices (e.g. wireless adapter, Bluetooth adapter) of the device 800. A Local Resource Handler 804 can be operable to handle the device components that are physically present on the device 800 and effectively direct access to the local device drivers. A Resource Discovery Manager (RDM) 806 can be operable to communicate with other devices and collect data related to components of other devices that are available for use by the device 800. The collected data can be delivered to the Resource Importer (RI) 808. As will be appreciated by those skilled in the art, the Resource Importer (RI) 808 can be operable to receive the collected data related to the available remote components from the RDM 806 and provides a list of these components to a Smart Decision Maker (SDM) 810. In addition, the Resource Importer (RI) 808 can be operable to handle access to remote devices and interact with RDM 806 to gather information. The SDM 810 can report the information and receive I/O requests. The SDM 810 can also interact with Security and Reliability Monitor 811 to determine which remote components can be utilized. The Resource Importer (RI) RI 808 can also be operable to gather statistics regarding network traffic and delay with assistance of RDM 806. Security and Reliability Monitor 811 can be operable to enforce sharing policies and/or rules and make decisions on whether to permit importing or exporting of one or more I/O resources using the CML Communication Protocol Module 802 or even whether to allow communication with a remote device. The Security and Reliability Monitor 811 can also be operable to interact with Resource Importer 808, Resource Exporter 814, Resource Discovery Manager 806, Remote Request Handler 816, CML communication protocol 802, and Smart Decision Maker 810. It should be noted that the Remote Request Handler 816 can be operable to receive access requests from remote devices and forward the granted requests to the Resource Exporter 814. The Resource Exporter 814 can operable to: (i) serve the remote requests received from a Remote Request Handler (RRH) 816, (ii) assist in deciding which I/O resources to export at a given time by using an Export Control Monitor (ECM) 819, a Resource Utilization Prober (RUP) 820 and/or the Smart Decision Maker (SDM) 810.

The Smart Decision Maker (SDM) 810 can be relatively sophisticated. It can gather various the information including available remote components, local utilizations, network delays, etc. in order to make decisions regarding optimizing the usage of local and remote resources. The Smart Decision Maker (SDM) 810 can receive local requests from the Local Request Handler (LRH) 805 and decide whether a local or a remote I/O resource should serve an I/O request based on collected data (or statistics). In addition, the Smart Decision Maker (SDM) 810 can also interact with the Resource Exporter 814 to temporarily disallow sharing of some local resources (e.g., disallow sharing until the utilization of the resource comes down to a lower level). Generally, SDM 810 can manage and/or orchestrate virtually all of the main operations relating to Coalition Management of I/O. Local Request Handler (LRH) 805 can be operable to receive requests of local processes and deliver them to the SDM 810. As will be appreciated by those skilled in the art, it may not be necessary to provide one or more of the exemplary components (or modules) discussed above. In addition, it is possible to combine two or more of the components and/or extent functionalities across various modules based on design requirements and/or other factors (cost, available resources) pertaining to a specific situation.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computing device, comprising:
one or more internal input output (I/O) devices;
an Input-Output system operable to:
effectively share said one or more internal input output (I/O) devices with one or more other computing devices; and
effectively facilitate sharing and/or cause sharing of one or more external input output (I/O) devices of said one or more other computing devices with said computing device.

2. The computing device of claim 1, wherein said Input-Output system includes a Virtual Environment operable to effectively simulate an internal input output (I/O) environment for use of said one or more external input output (I/O) devices by said computing device, thereby allowing a first executable computer code operating on said computing device to effectively use said one or more external (I/O) devices of said one or more other computing devices in the same manner as said first executable computer code would use said one or more internal input output (I/O) devices of said computing device.

3. The computing device of claim 2, wherein said Virtual Environment is further operable to effectively allow said first executable computer code to use a first interface for accessing said one or more internal input output (I/O) devices in order to also use said one or more external input output (I/O) devices, thereby allowing said first executable computer code to effectively use said one or more external input output (I/O) devices without requiring modification of said first interface or addition of a second interface for using said one or more external input output (I/O) devices.

4. The computing device of claim 3, wherein said Virtual Environment is further operable to effectively allow said first executable computer code to use said one or more external input output (I/O) devices without requiring said first executable computer code to explicitly or specifically make a request for said one or more external input output (I/O) devices.

5. The computing device of claim 2, wherein said Virtual Environment includes a Virtual Device Driver (VDD) operable to interface with said first executable computer code and effectively emulate a physical device driver of said computing device.

6. The computing device of claim 2, wherein said Virtual Environment is further operable to effectively simulate an external input-output (I/O) computing environment for use of said one or more internal input output (IO) devices by said one or more other computing devices, thereby allowing one or more second executable computer program codes executing on said one or more other computing devices to effectively use said one or more internal input output (I/O) devices of said computing device as their own internal input output (I/O) devices.

7. The computing device of claim 6, wherein said Virtual Environment includes one or more Virtual Drive Drivers (VDDs) respectively provided for using said one or more internal input output (I/O) devices of said computing device.

8. The computing device of claim 1, wherein said Input-Output system is provided in and/or as an IOCM-capable operating system of said computing device such that said IOCM-capable operating system is operable to effectively simulate an internal input output (I/O) environment for use of said one or more external I/O devices, thereby allowing a first executable computer code executing on said computing device to effectively use said one or more external input output (I/O) devices of said one or more other computing devices in the same manner as said first executable computer code would uses the one or more internal input output I/O devices of said computing device.

9. The computing device of claim 8, wherein said IOCM-capable operating system is further operable to effectively allow said first executable computer code to use a first interface for accessing said one or more external input output (I/O) devices, thereby allowing said first executable computer code to effectively use said one or more external I/O devices without requiring modification of said first interface or addition of a second interface for using the external input output (I/O) devices.

10. The computing device of claim 9, wherein said IOCM-capable operating system is further operable to effectively allow said first executable computer code to use said one or more external input output (I/O) devices without requiring said first executable computer code to explicitly or specifically make a request for said one or more external input output (I/O) devices.

11. The computing device of claim 1, wherein said Input-Output system is further operable to:
receive an input and/or output request from a first computer application program for using one or more input and/or outputs (I/O) functions;
determine whether to effectively provide said one or more input and/or outputs (I/O) functions via said one or more internal input output (I/O) devices of said computing device or via said one or more external input output (I/O) devices of said one or more other computing devices;
effectively provide said one or more input and/or outputs functions via said one or more internal input output (I/O) devices when said determines to effectively provide said one or more input and/or outputs functions via said one or more internal input output (I/O) devices; and
effectively provide said one or more input and/or outputs functions via said one or more external input output (I/O) devices when said determines to effectively provide said one or more input and/or outputs functions via said one or more internal input output I/O devices.

12. The computing device of claim 1, wherein said Input-Output system is further operable to:
effectively switch between: (i) use of a first internal input output (I/O) device of said one or more internal input output (I/O) devices, and (ii) use of a first external input output (I/O) device of said one or more external input output (I/O) devices.

13. The computing device of claim 1, wherein said Input-Output system is further operable to switch between: (i) use of a first internal input output (I/O) device of said one or more internal input output (I/O) devices, (ii) use of a first external input output (I/O) device of said one or more external input output (I/O) devices, and (iii) use of a second external input output (I/O) device of said one or more external input output (I/O) devices.

14. The computing device of claim 1, wherein said determining of whether to effectively provide said one or more input and/or output (I/O) functions via said one or more internal input output (I/O) devices of said computing device or via said one or more external input output (I/O) devices of said one or more other computing devices comprises one or more of the following:
determining whether said one or more internal input output (I/O) devices are supported by said one or more internal input output (I/O) devices of said computing system;
determining whether to provide said one or more internal input output (I/O) devices via said one or more internal input output (I/O) devices when said determining determines that said one or more internal input output (I/O) devices are supported by said one or more internal input output (I/O) devices of said computing system; and
determining whether said one or more internal input output (I/O) devices are supported by said one or more other computing systems when said determining determines that said one or more internal input output (I/O) devices are not supported by said one or more internal input output (I/O) devices of said computing system.

15. The computing device of claim 14, wherein said determining whether to provide said one or more internal input output (I/O) devices via said one or more internal input output (I/O) devices is determined based on one or more of the following:
monetary cost associated with using said one or more internal input output (I/O) devices;
current usage of said one or more internal input output (I/O) devices; and
current network bandwidth for accessing said one or more external input output (I/O) devices.

16. The computing device of claim 1, wherein said computing device is a Consumer Electronic (CE) device and said one or more other computing devices are one other Consumer Electronic (CE) devices.

17. In a computing system, a computer-implemented method of providing one or more input and/or output functions to executable computer code, wherein said computing system includes one or more internal input output (I/O) devices, and wherein said computer-implemented method comprises:
receiving, from said executable computer code, an I/O request for said one or more I/O functions, wherein said I/O request is not specifically addressed to another computing device or external I/O devices of another computing device;
determining whether to effectively provide said one or more input and/or output functions via said one or more internal input output (I/O) devices of said computing system or via one or more external input output (I/O) devices of one or more other computing systems;
effectively providing said one or more input and/or outputs functions via said one or more internal input output (I/O) devices when said determines to effectively provide said one or more input and/or outputs functions via said one or more internal input output (I/O) devices; and
effectively providing said one or more input and/or outputs functions via said one or more external input output (I/O) devices when said determining determines to effectively provide said one or more input and/or outputs (I/O) functions via said one or more external input output (I/O) devices.

18. The computer-implemented method of claim 17, wherein said computing system is and/or includes one or more computing devices and said one or more other computing systems are and/or include one or more other computing devices.

19. The computer-implemented method of claim 18, wherein said computing system includes a first computing device, and wherein said executable computer code includes a computer application program executed by said first computing device, and wherein said computer-implemented method further comprises:
requesting, by said computer application program being executed on said first computing device, said one or more I/O functions form said internal I/O devices; and
using one or more external input output (I/O) devices of a second computing device to provide said computer application program with said one or more I/O functions, thereby providing said I/O functions using said external input output (I/O) devices without requiring said computer application program to specifically make a request to said second computing device or specifically address said external input output (I/O) devices.

20. A computer readable storage medium storing executable computer program code for providing one or more input and/or output functions to a computer application program being executed on a computing system, wherein said computing system includes one or more internal input output (I/O) devices, and wherein said computer readable storage medium includes:
executable computer program code operable to receive, from said computing application program, an input output (I/O) request for said one or more I/O functions, wherein said I/O request is not specifically addressed to another computing device or external I/O devices of another computing device;
executable computer program code operable to determine whether to effectively provide said one or more input an/or output functions via said one or more internal input output (I/O) devices of said computing system or via one or more external input output (I/O) devices of one or more other computing systems;
effectively provide said one or more input and/or outputs functions via said one or more internal input output (I/O) devices when said determines to effectively provide said one or more input and/or outputs functions via said one or more internal input output (I/O) devices; and
effectively provide said one or more input and/or outputs functions via said one or more external input output (I/O) devices when said determines to effectively provide said one or more input and/or outputs (I/O) functions via said one or more external input output (I/O) devices.
